(19) United States
(12) Patent Application Publication
(10) Pub. No.: US 2003/0102070 A1
(43) Pub. Date: Jun. 5, 2003

(54) System, method, and computer program product for providing control for high speed fiber placement

(75) Inventors: Scott E. Black, Godfrey, IL (US); Lawrence Eric Pado, Saint Charles, MO (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 09/998,478

(22) Filed: Nov. 30, 2001

(51) Int. Cl. B32B 31/00

(52) U.S. Cl. 156/64; 156/359

(57) ABSTRACT

A heating control method and an associated system are provided for high rate fiber placement in the construction of composite materials. The heating control method includes measuring a temperature of a fiber tape, determining a velocity of the fiber tape, determining a feedback control value based on the temperature of the fiber tape and a target temperature of the fiber tape, determining a feedforward control value based on the target temperature of the fiber tape and the velocity of the fiber tape, determining a heat control value based on the feedback control value and the feedforward control value, and heating the fiber tape based on the heat control value. By employing the predictive nature of feedforward control, improved heating of the fiber tape is provided.

### GOVERNMENT LICENSE RIGHTS

The United States Government may have rights in this invention as provided for by the terms of Contract Number N00014-00-3-0004 awarded by the Office of Naval Research.

### FIELD OF THE INVENTION

The invention relates to the manufacture of composite articles and, more specifically, to a laser control system, method, and computer program product for heating fiber tapes during the manufacture of composite materials.

### BACKGROUND OF THE INVENTION

Composite structures made from fiber-reinforced polymer matrix (resin) materials are commonly manufactured by progressively building up the structure with a plurality of layers of thin composite tape or tow, hereafter collectively referred to as tape, laid one layer upon another. Typically, the operation begins by laying one or more tapes onto a starting template that has a configuration generally corresponding to the desired shape of the article to be produced. A tape placement head guides the one or more continuous tapes onto the template by providing relative movement between the template and the head, such that the head moves over the surface of the template. The head usually makes repeated passes over the template in a defined pattern until the template is entirely covered. Multiple layers of tape are built up by continued passes of the head over the surface. A compaction roller is usually used for pressing the tape against the template or prior-laid layers of tape, hereafter collectively referred to as a workpiece. Compaction facilitates adhesion of the tape to the workpiece.

The tape, the workpiece, or both are heated just prior to the tape being compacted and/or as the tape is being compacted to soften the resin and promote adhesion of the tape to the workpiece. Proper heating is important in the manufacturing process. Excessive heating can disfigure or damage the fiber tapes and insufficient or excessive heating can result in adhesion problems which increase the likelihood of separation of the successive layers of tape, thereby decreasing the strength of the finished article. Unfortunately, it is oftentimes difficult to remedy adhesion problems since the ideal degrees of heating and compacting are mutually dependent and also dependent on such factors as the type of fiber tape employed, the degree of impregnation of the fiber tape, the rate at which the fiber tapes are placed, and ambient conditions, to name a few.

Lasers can quickly alter the temperature of the fiber tape, the workpiece, or both. If a feedback system is used, the laser power can be increased or decreased to respond to a fiber tape temperature that is higher or lower than appropriate. Traditional feedback control systems, however, have proven inadequate for providing an optimal response, often failing to maintain a sufficiently uniform temperature for successive sections of fiber tapes. This problem can be especially acute during changes in the rate of placement of the fiber tapes. Changes in the rate of placement may occur during start-up and shut-down as well as during normal operation. For example, during start-up and shut-down, the fiber placement head may quickly adjust the rate of placement of the fiber tapes. Additionally, geometric variations in the contour of the workpiece can require the fiber placement head to quickly change the rate of placement of the fibers. Thus, in some instances, a traditional feedback control system that responds only to discrepancies between a target temperature of the fiber tapes and the actual temperature of the fiber tapes cannot provide a control response that is capable of maintaining a sufficient uniform temperature. Therefore there exists a need for a heating control system and a heating control method for quickly and appropriately reacting to variations in temperature and rate of placement of the tapes.

### SUMMARY OF THE INVENTION

The present invention seeks to improve the quality of composite materials and the efficiency of their production by providing a system, method, and computer program product to more precisely control the heating based upon both feedback and feedforward controls. Utilization of feedback and feedforward controls permits the heating of the fiber tapes to be quickly adjusted so that the tapes are maintained at a temperature that is equal or nearly equal to a target temperature. By maintaining proper heating of the fiber tapes, the fiber placement machine is able to improve the adhesion of the fiber tapes to the workpiece and the overall quality of the composite structure.

In one embodiment, the fiber placement machine includes a heating device, such as a laser diode array, that heats at least one fiber tape, and a compaction roller then compacts the fiber tape onto a workpiece in a compaction region. The fiber tape therefore conforms to the contour of the workpiece and is adhered thereto. The fiber placement machine also includes a temperature sensor and a velocity sensor that respectively measure the temperature and velocity of the fiber tape. The velocity of the fiber tape is generally the velocity of the fiber tape with respect to the fiber placement head, that is the rate of placement of the fiber tape. Because the fiber placement head moves relative to the workpiece, or the workpiece moves relative to the fiber placement head, the velocity of the fiber tape is also typically equal to the velocity of the fiber placement head with respect to the workpiece.

The fiber placement machine of one advantageous embodiment further comprises three controllers: a feedback controller, a feedforward controller, and a heating device controller. The feedback controller determines a feedback control value based on the temperature output of the temperature sensor and a target temperature, which is a value based on the desired temperature of the fiber tape. The feedback controller now provides the feedback control value to the heating device controller. The feedback controller can use one of several known methods for determining the feedback control value, such as on-off control, proportional control, proportional-derivative control, proportional-integral control, proportional-integral-differential control, a three mode controller, artificial intelligence control, and the like.

The feedforward controller determines a feedforward control value based on the velocity output provided by the velocity sensor and the target temperature. The feedforward controller then provides the feedforward control value to the heating device controller. The feedforward controller can determine the feedforward control value using a feedforward data table or by mathematically calculating the feedforward control value based on the target temperature and the velocity of the fiber tape. For example, the feedforward controller can determine the feedforward control value by retrieving a value from a stored feedforward data table that comprises a number of data points. Each data point may correlate a velocity of the fiber tape, a temperature of the fiber tape, and a feedforward control value. Thus, based on the target temperature and the velocity of the fiber tape, the feedforward controller retrieves the corresponding feedforward control value. Alternatively, the feedforward controller can mathematically determine the feedforward control value by using a formula that defines the feedforward control value as a function of the target temperature and the velocity of the fiber tapes. The formula may be determined theoretically or empirically.

The heating device controller receives the feedback control and the feedforward control and determines a heat control value based thereon. In some embodiments, the heating device controller determines heat control value by summing the feedback control value and the feedforward control value. The heating device controller produces the heat control value to the heating device which, in turn, heats the fiber tape at least partially in accordance with the heat control value.

The heating control system, method, and computer program product of the present invention therefore enable the fiber placement machine to maintain the temperature of the fiber tapes with less variation from the target temperature as compared with other heating control systems. This is especially advantageous for rapid variations in manufacturing processes where the velocity of the fiber tape changes quickly, for example, during start-up, shut-down, pausing, and fiber placement on contoured workpieces, in which cases the temperature would otherwise generally vary greatly. Thus, the heating control system, method and computer program method of the present invention enables a fiber placement machine to operate at a higher capacity and achieve higher quality in the composite articles that are produced.

### BRIEF DESCRIPTION OF THE DRAWINGS

Having thus described the invention in general terms, reference will now be made to the accompanying drawings, which are not necessarily drawn to scale, and wherein:

FIG. 1 illustrates a fiber placement head used in conjunction with the heating control system of one embodiment of the present invention;

FIG. 2 is a block diagram showing the internal communication between the various components of the heating control system of one embodiment of the present invention;

FIG. 3 is a flow chart that illustrates the operations performed by the heating control system, method, and computer program product of one embodiment of the invention;

FIG. 4 is a graph that illustrates variations in velocity, laser control voltage, and temperature of a fiber tape during operation of a fiber placement machine that uses a feedback controller and no feedforward controller; and

FIG. 5 is a graph that illustrates variations in velocity, laser control voltage, and temperature of a fiber tape during operation of a fiber placement machine according to one embodiment of the invention that uses a feedback controller and a feedforward controller.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

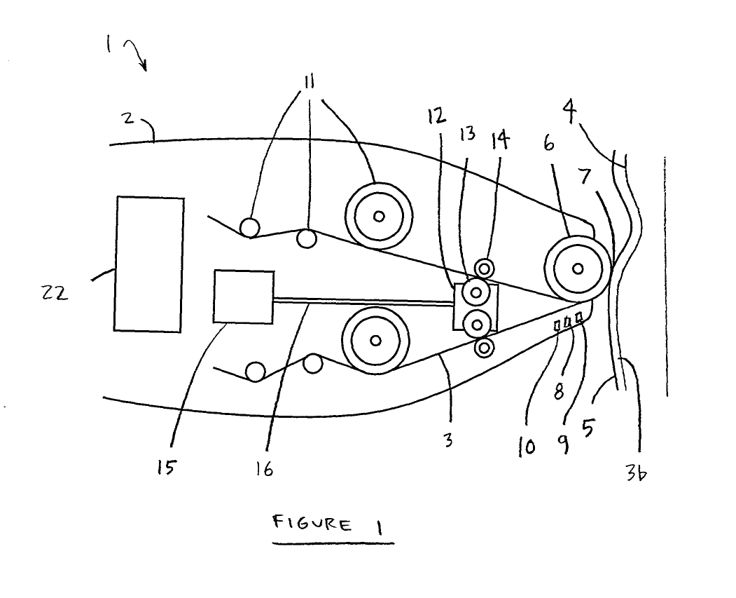

FIG. 1 shows one embodiment of a fiber placement machine according to the present invention, which is broadly denoted by reference numeral 1. A fiber tape 3 is guided in place by a fiber placement head 2 and placed on a contoured workpiece 5. In this example, the workpiece 5 is composed of a template 4 and a layer composed of fiber tapes 3b that have already been placed and compacted. Thus, the template 4 and any fiber tapes 3b placed thereon are collectively referred to hereinafter as the workpiece 5. A force is applied by a compaction device, here a compaction roller 6, in a direction generally towards the workpiece 5 so that the compaction roller 6 exerts pressure on the fiber tape 3 to press it against the workpiece 5 in a compaction region 7.

A fiber placement head is denoted by reference numeral 2. Although one embodiment of a fiber placement head 2 is illustrated and described, the fiber placement head 2 may be configured in other manners if so described. The fiber placement head 2 of this embodiment comprises a number of cold rollers, collectively referred to as a cold roller assembly 11. The cold roller assembly 11 guides the fiber tapes 3 to a drive roller assembly 12. The drive roller assembly 12 comprises drive rollers 13 and slave rollers 14. The drive rollers 13 are driven by a drive roller motor 15 which is linked to the drive rollers 13 by a drive transfer 16. In this example, the drive transfer 16 is a drive shaft, though it may also be a chain, belt, or gear assembly. The drive rollers 13 rotate and impart motion to the fiber tapes 3, transporting the fiber tapes 2 toward the compaction roller 5.

The fiber placement head 2 is moved relative to the workpiece 5 by a head drive assembly 22 which is generally shown in FIG. 1. The head drive assembly 22 may comprise any of a number of drive devices including, but not limited to, pneumatic or hydraulic actuators, electrical motors or servos, and/or chain, gear or shaft drive mechanisms. In FIG. 1, the fiber placement head 2 moves in a downwardly direction as it places the fiber tape 3, although the workpiece 5 may move instead of or in addition to the movement of the fiber placement head 2. As the fiber tape 3 is placed, the compaction roller 6 rotates, in this example counter-clockwise, to stay in rolling contact with the fiber tape 3. While a compaction roller 6 is depicted, other types of compaction devices may be utilized, such as a compaction shoe or a press.

The fiber placement machine 1 also includes a heating device 8. The heating device 8 may be a laser, a laser diode array, a hot gas torch, an electric heater, or any other heating device known in the art. The heating device 8 is used to heat the fiber tape 3 and/or the workpiece 5. The heating device 8 imparts thermal energy in the fiber tape 3, for example by directing laser light from a laser diode onto the fiber tape 3. In addition to or as an alternative to the heating of the fiber tapes 3, the heating device 8 may heat the workpiece 5. Regardless of whether the fiber tapes 3 and/or the workpiece 5 are heated, the heating device 8 preferably delivers sufficient energy to permit the fiber tapes 3, once subjected to the compaction forces, to adhere to the underlying workpiece 5. Where the heating device 8 is a laser diode array, as in this embodiment, the laser diode array comprises a number of laser diodes. In one such embodiment, each laser diode is electrically coupled to a power source in a manner independent of the other laser diodes so that the operating power of each laser diode can be controlled independently of the other laser diodes. The laser diode array is described in further detail in U.S. patent application Ser. No. 09/578,069, entitled “Method for Heating and Controlling Temperature of Composite Material During Automated Placement,” which is herein incorporated by reference. Further, the individual diodes of the laser diode array may be arranged so that the light from each laser diode is focused on a different area or irradiation zone, though some of the irradiation zones may overlap. Different irradiation zones cover the different fiber tapes 3 and/or areas of the workpiece 5. Thus, by altering the operating power of one or more diodes, the heating of a particular fiber tape 3 and/or a particular area of the workpiece 5 can be controlled independently of the heating of other fiber tapes 3 and other areas of the workpiece 5. Non-uniform heating of the irradiation zones may be desirable, for example, if the fiber tapes 3 are not the same size or are not made of the same materials and thus require different amounts of energy to attain their optimum temperature for placement. Also, different amounts of heating may be desirable due to the geometry of the workpiece 5. For example, if the fiber placement machine 1 is placing fiber tape 3 along a curved path, the fiber tapes 3 being placed on the outside of the curve will follow a curve of greater radius and will be placed at a faster rate than the fiber tapes 3 on the inside of the curve. Thus, those fiber tapes 3 on the outside of the curve may require more heating than the fiber tapes 3 on the inside of the curve. Additionally, the workpiece 5 may require varying amounts of heat depending, for example, on its current temperature and chemical and structural makeup.

The fiber placement machine 1 may also include a number of other components. For example, the fiber placement machine may include an inspection system comprising cameras, temperature sensors, pre-placement detectors, tack monitoring devices, and the like for monitoring the fiber tape 3. Additionally, the fiber placement machine may include a marking device for defect marking.

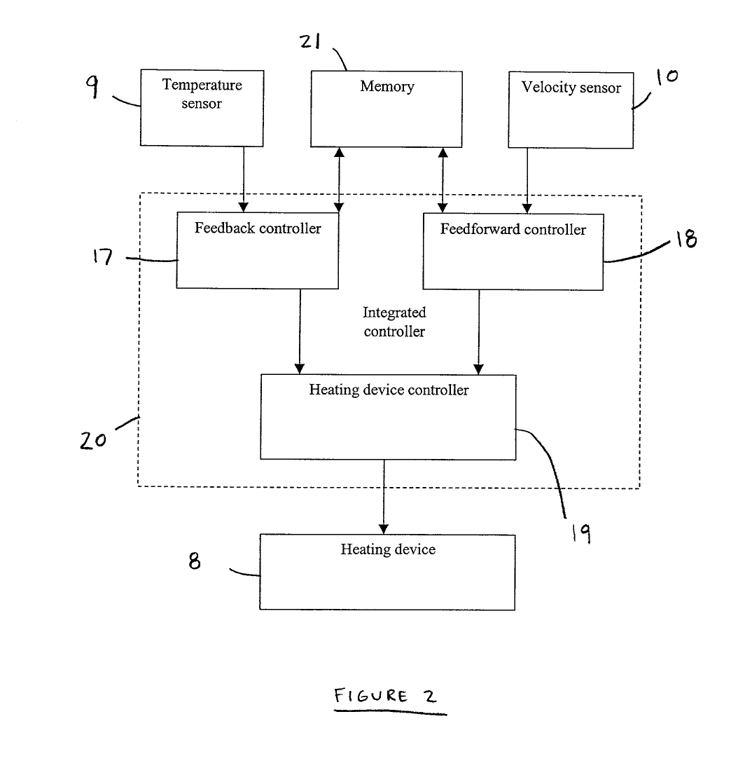

The heating device 8 is controlled by a heating control system 23 which is more clearly shown in FIG. 2. The block diagram shown in FIG. 2 illustrates the internal communication that occurs between various components of the heating control system 23 of one embodiment of the present invention. In this embodiment, the heating control system 23 comprises three controllers: a feedback controller 17, a feedforward controller 18, and a heating device controller 19, each of which is typically a microcontroller, a processor, or other computing device. The three controllers 17, 18, and 19 may be discrete controllers that are electrically connected to one another so that each can communicate with one another. In other embodiments, any two or all three of the feedback controller 17, the feedforward controller 18, and the heating device controller 19 may comprise a single integrated controller, which is denoted as reference numeral 20 in FIG. 2. Additionally, the integrated controller 20 may also perform other functions, for example functions integral to inspection, speed control, temperature and velocity sensing, defect marking, and the like.

Although some of the components shown in FIG. 2 are not directly connected to one another, this arrangement is shown for clarity and it is understood that any one of the components of the fiber placement machine 1 may be electrically connected to another component. For example, the feedforward controller 18 may be electrically connected directly to the temperature sensor 9 even though that connection is not shown in the figure.

In one embodiment of the invention, the heating control system 23 functions in the following manner. The temperature sensor 9 and the velocity sensor 10 respectively generate a temperature output based on the temperature of the fiber tape 3 and a velocity output based on the velocity of the fiber tape 3. While various temperature sensors 9 and velocity sensors 10 may be utilized, the system of one embodiment includes an infrared emission sensor as a temperature sensor 9 and a laser doppler velocimeter as a velocity sensor 10. Other temperature sensors 9 include thermocouples and other known temperature sensing devices. Other velocity sensors 10 include mechanical devices, such as a roller with an attached rotational speed measuring device, as well as other mechanical and electrical devices known in the art. A target temperature, stored in a memory 21, is a value based on the desired temperature of the fiber tape 3. The target temperature may be manually set once or repeatedly during subsequent operations of the fiber placement machine 1. Alternatively, the target temperature may be set automatically, for example according to the properties of the fiber tape 3 that is used. Typically, the target temperature is stored in a memory device 21.

In operation, the feedback controller 17 receives the temperature output from the temperature sensor 9 and retrieves the target temperature from the memory device 21. Although a single temperature sensor 9 is shown in FIG. 2, there may actually be any number of temperature sensors 9. Additionally, the temperature sensor 9 may check the temperature of the fiber tape at any location, for example after the fiber tape 3 has been heated but before it is compacted or after compaction onto the workpiece 5. The feedback controller 17 then determines a feedback control value based on the temperature output and the target temperature and sends the feedback control value to the heating device controller 19. The feedback controller 17 can use one of several known methods for determining the feedback control value, such as on-off control, proportional control, proportional-derivative control, proportional-integral control, proportional-integral-differential control, a three mode controller, artificial intelligence control, and the like as known to those skilled in the art, some of which are described in more detail below.

The feedforward controller 18 receives the velocity output from the velocity sensor and retrieves the target temperature from the memory device 21. The feedforward controller 17 then determines a feedforward control value based on the velocity output and the target temperature and sends the feedforward control value to the heating device controller 19. The feedforward controller 18 can determine the feedforward control value in various manners, such as by using a feedforward data table or by mathematically determining the feedforward control value based on the target temperature and the velocity of the fiber tape 3. Both of these methods are described more fully in the description below.

The heating device controller 19 receives the feedback control and the feedforward control and determines a heat control value based thereon. In some embodiments, the heating device controller 19 determines heat control value by summing the feedback control value and the feedforward control value. Alternatively, the heating device controller 19 may perform a weighted summation by first multiplying each of the feedback control value and the feedforward control value by respective weighting factors and then summing the two products. The heating device controller 19 sends a control signal that equals or is otherwise based on the heat control value to the heating device 8. As described above, the heating device 8 may be a laser, a laser diode array, a hot gas torch, an electric heater, or any other heating device known in the art. The heating device 8 may increase, decrease, or maintain the current heating of the fiber depending on the heat control value, i.e., depending upon whether the heat control value increases, decreases, or remains the same relative to prior heat control values.

Although the foregoing discussion describes a system wherein a single feedback control value, feedforward control value, and heat control value are used, it is understood that any number of control values may be generated simultaneously. For example, one or more temperature sensors 9 may monitor a number of different sensing zones on one or more fiber tapes 3 and/or the workpiece 5. Similarly one or more velocity sensors 10 may monitor the respective velocities of a plurality of fiber tapes 3. The feedback controller 17, feedforward controller 18, and heating device controller 19 may then generate a plurality of heat control values, each of which corresponds to one of the sensing zones. Thus, the heating device 8 can respond independently to different fiber tapes 3 or different areas of fiber tapes 3 and/or the workpiece 5. For example, when a laser diode array is used as the heating device 8, and the individual diodes of the laser diode array are arranged to heat different irradiation zones as described above, the different heat control values can be utilized to independently control the power of the individual laser diodes.

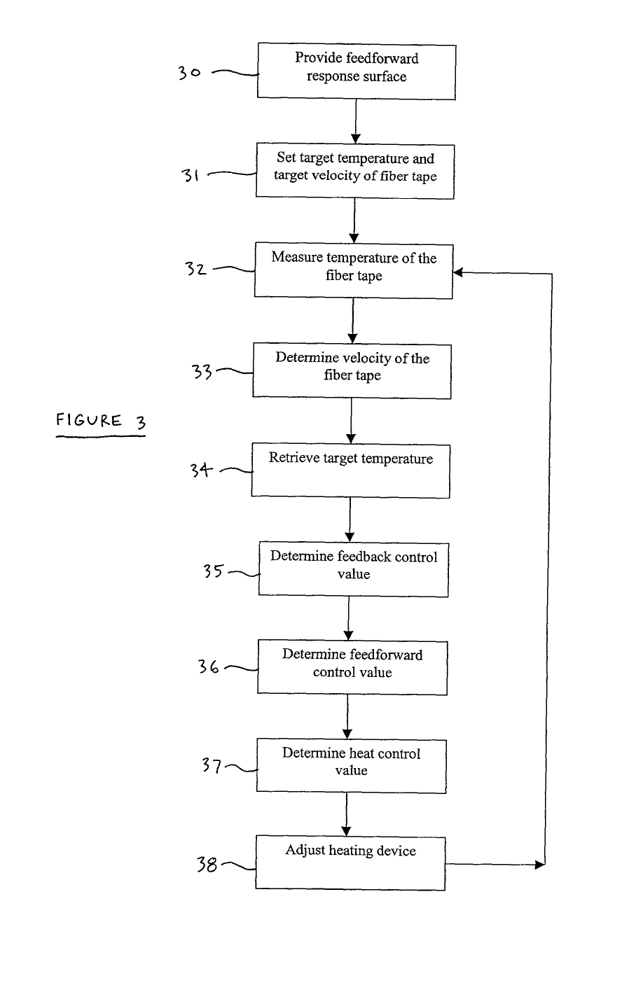

The flow chart shown in FIG. 3 illustrates the steps of one embodiment of the present invention. It is understood that any of the operations performed by the feedback controller 17, the feedforward controller 18, and the heating controller 19 may alternatively be performed by the single integrated controller 20 or by any type of distributed control technique.

Referring now to the first step of FIG. 3, denoted by reference numeral 30, it can be seen that in this embodiment a feedforward response surface is first provided. The feedforward response surface defines a plurality of data points. Each data point correlates a predefined velocity of the fiber tape 3, a predefined feedforward control value, and a resulting temperature of the fiber tape 3. Specifically, the response surface defines the data points in one of two ways. First, in one embodiment, the response surface comprises a feedforward data table of data points. Each data point correlates a predefined velocity of the fiber tape 3, a predefined feedforward control value, and a resulting temperature of the fiber tape 3. The data points that are stored in the feedforward data table may be determined by experimental or theoretical methods. For example, each data point in the table can be determined by operating the fiber placement machine 1 at a predefined velocity, using a predefined feedforward control value as the heat control value, and measuring the resulting temperature of the fiber tape 3. Alternatively, the data points can be determined by theoretically predicting the resulting temperature for a predefined velocity and predefined feedforward control value.

In another embodiment, the feedforward response surface defines a plurality of data points according to a mathematical correlation between a predefined velocity of the fiber tape 3, predefined feedforward control value, and the resulting temperature of the fiber tape 3. Similar to the embodiment that utilizes a feedforward data table, this embodiment provides for the determination of the mathematical correlation through theoretical or experimental methods. In one embodiment, the feedforward formula is determined by fitting a surface to a set of data points in a feedforward data table. The fitting may be performed by any known method, for example the least squares method, and the feedforward formula may be of any order. For example, in one preferred embodiment the feedforward formula is second order and takes the following form:

FCV(t)=B₀+B_{V}*V+B_{T}*T+B_{VT}*V*T+B_{TT}*T²

where FCV(t) is the predefined feedforward control value as a function of time, t; T is the target temperature; V is the predefined velocity of the fiber tape; and B₀, B_{V}, B_{T}, B_{VT}, and B_{TT} are predefined coefficients. The coefficients B₀, B_{V}, B_{T}, B_{VT}, and B_{TT} are summarized in a column matrix B as:

$$B = [ \begin{matrix}{B}_{0} \\ {B}_{V} \\ {B}_{T} \\ {B}_{VT} \\ {B}_{TT}\end{matrix} ]$$

If there are known a plurality of data points, each point correlating a predefined tape velocity, a predefined feedforward control value, and a resulting temperature, the matrix B can be determined by the equation:

B=(X^{T}X)⁻¹(X^{T}Y)

where X is an input matrix; X^{T} is the transpose of X; and Y is the output matrix.

The input matrix X and output matrix Y are defined by the following expressions:

$$X = ( \begin{matrix}1 & {V}_{1} & {T}_{1} & {V}_{1} {T}_{1} & {T}_{1}^{2} \\ 1 & {V}_{2} & {T}_{2} & {V}_{2} {T}_{2} & {T}_{2}^{2} \\ ⋮ & ⋮ & ⋮ & ⋮ & ⋮ \\ 1 & {V}_{n} & {T}_{n} & {V}_{n} {T}_{n} & {T}_{n}^{2} \end{matrix} )$$

$$and$$

$$Y = [ \begin{matrix}{FCV}_{1} \\ {FCV}_{2} \\ ⋮ \\ {FCV}_{n}\end{matrix} ] \\$$

where V₁, V₂, . . . Vₙ are a plurality of predefined tape velocity values; T₁, T₂, . . . Tₙ are a plurality of corresponding tape temperature values and FCV₁, FCV₂, . . . FCVₙ, are a plurality of corresponding predefined feedforward control values such that the predefined feedforward control value FCVₙ and predefined tape velocity Vₙ result in tape temperature Tₙ. Thus, the first row of the input matrix X contains the terms 1, V₁, T₁, V₁T₁, and T₂². The second row of the input matrix X contains the terms 1, V₂, T₂, V₂T₂, and T₂², and so forth. Similarly, the first row of the output matrix Y contains the term FCV₁, the second row contains the term FCV₂, and so forth.

The data points of the input matrix X and output matrix Y can be determined theoretically or empirically. For example, a series of tests can be conducted to determine a plurality of data points, each data point representing a laser voltage, a feed rate, and a resulting temperature. For example, the following table contains a plurality of data points:

| | V = 100 | V = 200 | V = 400 | V = 600 | V = 800 | V = 1000 | V = 1200 |
|---|---|---|---|---|---|---|---|
| FCV = 0.5 | | | 78 | | | 72 | |
| FCV = 1 | 155 | | 110 | | 97 | 89 | 88 |
| FCV = 1.5 | 216 | 164 | 140 | | 110 | 104 | 100 |
| FCV = 2 | | 212 | 177 | | 125 | 121 | 120 |
| FCV = 2.5 | | | 209 | 158 | 142 | 133 | 127 |
| FCV = 3 | | | 228 | 166 | 160 | 149 | 139 |
| FCV = 3.5 | | | 263 | 190 | 176 | 167 | 154 |
| FCV = 4 | | | 283 | | 189 | 175 | 168 |
| FCV = 4.5 | | | 290 | | 202 | 184 | 182 |

Thus, the above table contains a number of data points, each point correlating a predefined velocity of the fiber tape 3, a predefined feedforward control value, and a temperature of the fiber tape 3. The values shown were determined by conducting a series of tests wherein during each test the velocity of the fiber tape 3 was set to a predefined velocity denoted V in the table, the feedforward control value was set to a predefined value denoted FCV in the table, and the resulting temperature of the fiber tape 3 was then measured. Each test was conducted for a specific target temperature. For example, when the fiber tape 3 was placed at a velocity of 400 inches per minute, and the feedforward control value was set to 3 volts, the fiber tape had a resulting temperature of 228° F. If this table were used by the feedforward controller 18 to determine the feedforward control value, the feedforward controller 18 would find the appropriate feedforward control value that corresponds to the target temperature of the fiber tape 3 and the velocity of the fiber tape 3. For example, if the target temperature and the velocity were 176° F. and 800 inches per minute, respectively, the feedforward controller 18 would retrieve the feedforward control value of 3.5 volts.

It should be noted that the above table does not include data points for every possible combination of velocity and feedforward control value. Thus if the feedforward controller 18 attempts to retrieve a feedforward control value for a target temperature or a velocity that is not shown on the table, the feedforward controller 18 could select a feedforward control value from the data point that lies closest. Alternatively, the feedforward controller 18 could interpolate or extrapolate as necessary to approximate the appropriate feedforward control value.

It should also be noted that the above table was constructed using a constant target temperature. Therefore, a different table may be required if a different target temperature is used, for example because a different fiber tape 3 is used. Alternatively, instead of associating each feedforward control table with a specific target temperature, a more complicated table could be constructed that defines the feedforward control values as a function of the temperature as well as the temperature and the velocity of the fiber tapes 3.

Referring to the second step, denoted by reference numeral 31, a target temperature and target velocity are set. Both the target temperature and target velocity can be set before or during operation of the fiber placement machine 1 and can be set either manually by an operator or automatically based on other system parameters, for example previously determined optimum values based on the size and type of the fiber tape 3.

In step 32, the temperature sensor 9 determines the temperature of the fiber tape 3 and/or the workpiece 5 and the temperature output is sent to the feedback controller 17. In step 33, the velocity of the fiber tape 3 is determined. As stated above, the velocity can be measured by the velocity sensor 10. The velocity sensor 10 can measure the velocity of the fiber tape 3 by any known means, for example, using a contacting sensor or preferably by a non-contacting method such as laser doppler velocimetry. The velocity sensor 10 may also determine the velocity of the fiber tape 3 by monitoring the speed of another component of the fiber placement machine 1. For example, the velocity sensor 10 could monitor the speed of the fiber placement head 2 relative to the workpiece 5 or the rotational speed of one of the rollers in the drive roller assembly 12 or cold roller assembly 11. Alternatively, the feedforward controller 18 can retrieve a target velocity which was stored in the memory device 21 before or during operation of the fiber placement machine 1 in a fashion similar to the storing of the target temperature described above. The velocity of the fiber tape 3 is then determined based on the stored target velocity. For example, a target velocity may be set manually by an operator or automatically based on other system parameters, for example previously determined optimum values based on the size and type of the fiber tape 3. The target velocity is stored in the memory device 21 where it can be retrieved by the feedforward controller 18. The feedforward controller 18 can then determine the velocity of the fiber tape 3 by defining the velocity to be equal to the target velocity.

In step 34, the feedback controller 17 and/or the feedforward controller 18 retrieve the target temperature. In step 35, the feedback controller 17 calculates a feedback control value based on the temperature of the fiber tape 3 and the target temperature of the fiber tape 3. There are a number of methods for generating feedback control values, for example a simple on-off control method, a proportional control method, a proportional-derivative control method, or a proportional-integral-derivative control method. In the on-off control method, a feedback control value is determined by first comparing the temperature of the fiber tape 3 to the target temperature. If the target temperature is greater than the temperature of the fiber tape 3, the feedback control value is set to one, which will subsequently cause the heating device controller 19 to begin heating. If the target temperature is less than or equal to the temperature of the fiber tape 3, the feedback control value is set to zero, and the heating device controller will subsequently cause the heating device to cease heating. With most other control methods, the heating device controller 19 may generate heat control values that are between zero and one, that is, the heating control values may cause the heating device 8 to increase or decrease heating in incremental stages between full on and off. For example, in a proportional control method, the feedback control value is calculated by multiplying a proportional gain by the temperature error, which is the difference between the target temperature and the temperature of the fiber tape 3. Similarly, in a proportional-derivative control method, the feedback control value is calculated by multiplying a proportional gain by the temperature error, but the result is adjusted by adding a second term that is proportional to the time-derivative of the temperature error. The proportional-integral-differential control method goes one step further than the proportional-derivative control method by adding a third term that is proportional to the time integral of the temperature error. Thus, the proportional-integral-differential control method is a three mode controller. A preferred embodiment of the invention uses the proportional-integral-differential control method to calculate the feedback control value.

In step 36, the feedforward controller 18 determines a feedforward control value based on the velocity of the fiber tape 3 and the target temperature and according to a feedforward response surface. As described above, the feedforward response surface can define a plurality of data points by comprising a feedforward data table or by defining a mathematical correlation between a plurality of predefined velocities, predefined feedforward control values, and resulting temperatures. Thus, during operation of the fiber placement machine 1, the feedforward control value can be determined in at least two ways. In one embodiment, the feedforward control value is determined by retrieving a value from the feedforward data table. As described above, the feedforward data table contains data points, each of which represents a predefined feedforward control value, a predefined velocity of the fiber tape 3, and a temperature that results in the fiber tape 3 when the corresponding predefined feedforward control value is output to the heating device 8 and the fiber tape 3 moves at the corresponding predefined velocity. A number of feedforward data tables may be stored, so that a different data table can be used depending on construction conditions. For example, a distinct feedforward data table may be stored for each type of fiber tape 3 that is placed by the fiber placement machine 1. An operator can choose the feedforward data table that is used or the fiber placement machine 1 can automatically select a feedforward data table, for example by detecting the type of fiber tape 3 that is being placed by the fiber placement machine 1 and automatically selecting a feedforward data table that corresponds to that type of fiber tape 3.

In another embodiment, the feedforward controller 18 mathematically calculates the feedforward control value using the mathematical correlation between the predefined velocities, predefined feedforward control values, and resulting temperatures. The mathematical correlation can be determined by any known method, including fitting a surface to a plurality of data points as described above.

In step 37, the heating device controller 19 determines the heat control value using any of the methods described previously, such as by summing the feedforward control value and the feedback control value. The heat control value is then used to adjust the heating device as appropriate in step 38. As indicated in FIG. 3, the heating control method typically continues by returning to step 32. Of course, the system and method of present invention is not meant to be limited to this particular linear order of the steps. In other embodiments some of the steps may be performed in other orders, for example, measuring the temperature of the fiber tape 3 after determining the velocity of the fiber tape 3. Alternatively, some of the steps may be performed simultaneously. For example, the feedback control value and the feedforward control value could be determined simultaneously.

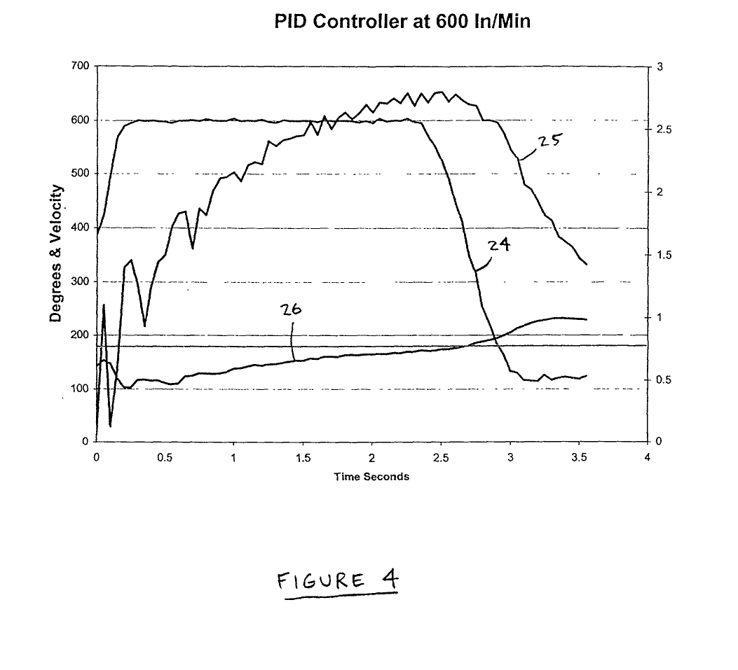

FIG. 4 graphically illustrates the results of a fiber placement machine 1 that used a feedback controller 17 but not a feedforward controller 18. The feedback controller 17 used a proportional-integral-derivative control method. The graph shows the velocity and temperature variation of the fiber tape 3, measured on the vertical axis, versus time in seconds, measured on the horizontal axis. The velocity of the fiber tape 3 is shown by the curve indicated by reference numeral 24 and is measured in inches per minute according to the vertical scale on the left side of the graph. The temperature of the fiber tape 3 is shown by the curve indicated by reference numeral 25 and is measured in degrees Fahrenheit according to the same vertical scale on the left side of the graph. The heat control value in this case comprises a voltage that controlled a heating device 8 comprising a laser diode array. The heat control value is shown by the curve denoted by reference numeral 26 and is measured in volts according to the vertical scale on right side of the graph. As can be seen, the trial lasted about 3.5 seconds. During that time, the velocity of the fiber tape 3 varied from about 400 inches/minute to a maximum of about 600 inches/minute and then slowed to about 120 inches/minute. The heat control value varied between about 0 volts and a maximum of about 2.8 volts. The resulting temperature of the fiber tape 3 varied between a minimum of about 100° F. and a maximum of about 230° F.

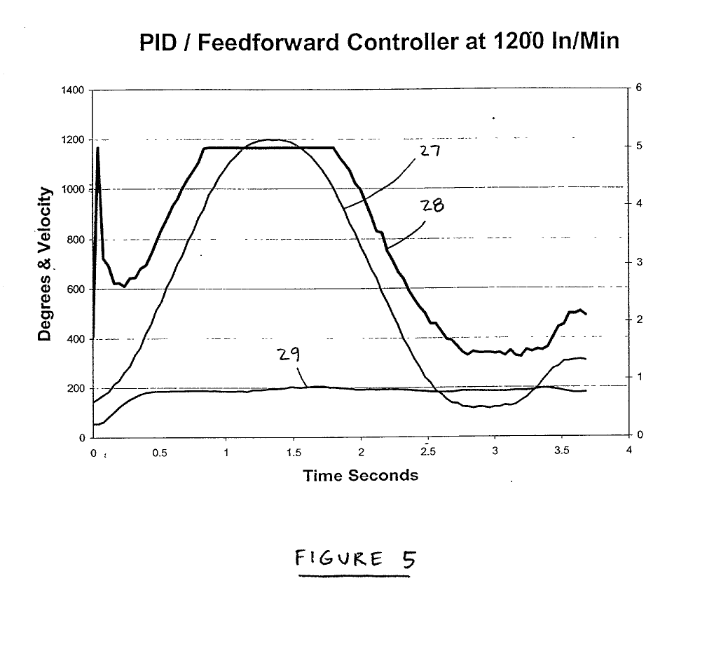

FIG. 5 illustrates the results of a fiber placement machine 1 according to one embodiment of the present invention that used both a feedback controller 17 and a feedforward controller 18. The feedback controller 17 used a proportional-integral-derivative control method. Similar to FIG. 4, the graph of FIG. 5 shows velocity, temperature, and time. The velocity of the fiber tape 3 is shown by the curve indicated by reference numeral 27, the temperature of the fiber tape 3 is indicated by numeral 28, and the heat control value is indicated by numeral 29. The units of measurement are the same as those used in FIG. 4, and the scales are located on the same axes. As can be seen from the graph, this trial lasted slightly longer than 3.5 seconds. During that time, the velocity of the fiber tape 3 varied between a minimum of about 150 inches/minute to a maximum of about 1200 inches/minute. The heat control value varied between about 1.5 volts and a maximum of about 5 volts. The resulting temperature of the fiber tape 3 varied between an initial value of about 60° F. and a maximum of about 200° F. The heat control value followed a much smoother variation in this trial than the previous trial shown in FIG. 4. Significantly, although the maximum velocity of the fiber tape 3 was twice that of the previous example shown in FIG. 4, the temperature remained nearly constant during most of the trial. Indeed, after a warm-up period of about 0.5 seconds, the temperature of the fiber tape 3 leveled and remained within a range of about 20° F. for the rest of the trial.

The system of the present invention is typically embodied by an integrated controller 20 and an associated memory device 21, both of which are commonly comprised by a computer or the like. As such, the system of the present invention generally operates under control of a computer program product according to another aspect of the present invention. The computer program product for performing the contingent claim valuation includes a computer-readable storage medium, such as the non-volatile storage medium, and computer-readable program code portions, such as a series of computer instructions, embodied in the computer-readable storage medium.

In this regard, FIGS. 2 and 3 are block diagrams and flowcharts of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of heating a fiber tape for forming a composite article, the method comprising:
providing a feedforward response surface that defines a plurality of data points, wherein each data point correlates a predefined velocity of the fiber tape, a predefined feedforward control value, and a resulting temperature of the fiber tape;
measuring a temperature of the fiber tape;
determining a velocity of the fiber tape;
determining a feedback control value based on the temperature of the fiber tape and a target temperature of the fiber tape;
determining a feedforward control value based on the target temperature of the fiber tape and the velocity of the fiber tape and according to the feedforward response surface;
determining a heat control value based on the feedback control value and the feedforward control value; and
heating the fiber tape based on the heat control value.

2. The method of heating a fiber tape of claim 1 wherein providing a feedforward response surface comprises constructing a feedforward data table of data points, each data point correlating a predefined velocity of the fiber tape, a predefined feedforward control value, and a resulting temperature of the fiber tape, and wherein determining a feedforward control value comprises retrieving a value from the feedforward data table based upon the target temperature and the velocity of the fiber tape.

3. The method of heating a fiber tape of claim 2 wherein the constructing step comprises:
operating a fiber placement machine at the predefined velocity of the fiber tape;
providing the predefined feedforward control value as a heat control value;
measuring the resulting temperature of the fiber tape;
storing the predefined velocity, the predefined feedforward control value, and the resulting temperature as a data point in the table of data points.

4. The method of heating a fiber tape of claim 2 wherein the constructing step comprises:
calculating the resulting temperature based on the predefined velocity of the fiber tape and the predefined feedforward control value; and
storing the predefined velocity, the predefined feedforward control value, and the resulting temperature as a data point in the table of data points.

5. The method of heating a fiber tape of claim 1 wherein the constructing step comprises mathematically defining a correlation between the predefined velocity, the predefined feedforward control value, and the resulting temperature of the fiber tape.

6. The method of heating a fiber tape of claim 5 wherein determining a feedforward control value comprises mathematically defining the feedforward control value according to the feedforward response surface and based on the target temperature and the velocity of the fiber tape.

7. The method of heating a fiber tape of claim 6 wherein determining the feedforward control value comprises mathematically defining the feedforward control value as:
FCV(t)=B₀+B_{V}*V+B_{T}*T+B_{VT}*V*T+B_{TT}*T²
wherein FCV(t) is the feedforward control value as a function of time, T is the target temperature, V is the velocity of the fiber tape, and B₀, B_{V}, B_{T}, B_{VT}, and B_{TT} are predefined coefficients.

8. The method of heating a fiber tape of claim 1 further including setting the target temperature of the fiber tape.

9. The method of heating a fiber tape of claim 1 wherein said step determining a velocity of the fiber tape comprises measuring the velocity of the fiber tape.

10. The method of heating a fiber tape of claim 1 further comprising setting a target velocity of the fiber tape and wherein determining a velocity of the fiber tape comprises determining the velocity of the fiber tape based on the target velocity of the fiber tape.

11. The method of heating a fiber tape of claim 1 wherein determining a feedback control value comprises determining the feedback control value utilizing proportional-integral-differential control.

12. The method of heating a fiber tape of claim 1 wherein determining a heat control value comprises summing the feedback control value and the feedforward control value.

13. A method of forming a composite article from a fiber tape, the method comprising:
providing a feedforward response surface that defines a plurality of data points, wherein each data point correlates a predefined velocity of the fiber tape, a predefined feedforward control value, and a resulting temperature of the fiber tape;
irradiating the fiber tape with a laser diode array;
compacting the irradiated fiber tape against a workpiece such that the fiber tape conforms to the contour of the workpiece and is adhered thereto;
measuring a temperature of the fiber tape;
determining a velocity of the fiber tape;
determining a feedback control value based on the temperature of the fiber tape and a target temperature of the fiber tape;
determining a feedforward control value based on the target temperature of the fiber tape and the velocity of the fiber tape and according to the feedforward response surface;
determining a heat control value based on the feedback control value and the feedforward control value; and
heating the fiber tape based on the heat control value.

14. The method of forming a composite article of claim 13 wherein providing a feedforward response surface comprises constructing a feedforward data table of data points, each data point correlating a predefined velocity of the fiber tape, a predefined feedforward control value, and a resulting temperature of the fiber tape, and wherein determining a feedforward control value comprises retrieving a value from the feedforward data table based upon the target temperature and the velocity of the fiber tape.

15. The method of forming a composite article of claim 13 wherein the constructing step comprises:
operating a fiber placement machine at the predefined velocity of the fiber tape;
providing the predefined feedforward control value as a heat control value;
measuring the resulting temperature of the fiber tape;
storing the predefined velocity, the predefined feedforward control value, and the resulting temperature as a data point in the table of data points.

16. The method of forming a composite article of claim 13 wherein the constructing step comprises:
calculating the resulting temperature based on the predefined velocity of the fiber tape and the predefined feedforward control value; and
storing the predefined velocity, the test feedforward control value, and the resulting temperature as a data point in the table of data points.

17. The method of forming a composite article of claim 13 wherein the constructing step comprises mathematically defining a correlation between the predefined velocity, the predefined feedforward control value, and the resulting temperature of the fiber tape.

18. The method of forming a composite article of claim 17 wherein determining a feedforward control value comprises mathematically defining the feedforward control value according to the feedforward response surface and based upon the target temperature and the velocity of the fiber tape.

19. The method of forming a composite article of claim 18 wherein determining the feedforward control value comprises mathematically defining the feedforward control value as:
FCV(t)=B₀+B_{V}*V+B_{T}*T+B_{VT}*V*T+B_{TT}*T²
wherein FCV(t) is the feedforward control value as a function of time, T is the target temperature, V is the velocity of the fiber tape, and B₀, B_{V}, B_{T}, B_{VT}, and B_{TT} are predefined coefficients.

20. The method of forming a composite article of claim 13 wherein determining a feedback control value comprises determining the feedback control value utilizing proportional-integral-differential control.

21. A computer program product for controlling fiber tape heating during formation of a composite article, the method comprising a computer-readable storage medium having computer-readable program code portions stored therein, the computer readable program code portions comprising:
a first executable portion for providing a feedforward response surface that defines a plurality of data points, wherein each data point correlates a predefined velocity of the fiber tape, a predefined feedforward control value, and a resulting temperature of the fiber tape;
a second executable portion for determining a feedback control value based on a temperature of the fiber tape and a target temperature of the fiber tape;
a third executable portion for determining a feedforward control value based on the target temperature of the fiber tape and a velocity of the fiber tape; and
a fourth executable portion for determining a heat control value based on a combination of both the feedback control value and the feedforward control value for controlling the fiber tape heating.

22. The computer program product according to claim 21 wherein the first executable portion is further capable of constructing a feedforward data table of data points, each data point correlating a predefined velocity of the fiber tape, a predefined feedforward control value, and a predefined of resulting temperature of the fiber tape, and wherein determining a feedforward control value comprises retrieving a value from the feedforward data table based upon the target temperature and the velocity of the fiber tape.

23. The computer program product according to claim 21 wherein the first executable portion is further capable of:
operating a fiber placement machine at the predefined velocity of the fiber tape;
providing the predefined feedforward control value as a heat control value;
measuring the resulting temperature of the fiber tape;
storing the predefined velocity, the predefined feedforward control value, and the resulting temperature as a data point in the table of data points.

24. The computer program product according to claim 21 wherein the first executable portion is further capable of:
calculating the resulting temperature based on the predefined velocity of the fiber tape and the predefined feedforward control value; and
storing the predefined velocity, the predefined feedforward control value, and the resulting temperature as a data point in the table of data points.

25. The computer program product according to claim 21 wherein the first executable portion is further capable of:
mathematically defining a correlation between the predefined velocity, the predefined feedforward control value, and the resulting temperature of the fiber tape.

26. The computer program product according to claim 25 wherein the third executable portion is further capable of:
determining a feedforward control value by mathematically defining the feedforward control value according to the feedforward response surface and based upon the target temperature and the velocity of the fiber tape.

27. The computer program product according to claim 26 wherein the third executable portion is further capable of:
determining the feedforward control value comprises mathematically defining the feedforward control value as:
FCV(t)=B₀+B_{V}*V+B_{T}+B_{VT}*V*T+B_{TT}*T²
wherein FCV(t) is the feedforward control value as a function of time, T is the target temperature, V is the velocity of the fiber tape, and B₀, B_{V}, B_{T}, B_{VT}, and B_{TT} are predefined coefficients.

28. The computer program product according to claim 21 wherein the second executable portion is further capable of:
determining a feedback control value by determining the feedback control value utilizing proportional-integral-differential control.

29. A system for controlling fiber tape heating during formation of a composite article, the system comprising:
a memory device, for storing a feedforward response surface that defines a plurality of data points, wherein each data point correlates a predefined velocity of the fiber tape, a predefined feedforward control value, and a resulting temperature of the fiber tape;
a feedback controller capable of determining a feedback control value based on a temperature of the fiber tape and a target temperature of the fiber tape;
a feedforward controller capable of determining a feedforward control value based on the target temperature of the fiber tape and a velocity of the fiber tape and according to the feedforward response surface; and
a heating device controller responsive to said feedback controller and said feedforward controller for determining a heat control value based on a combination of both the feedback control value and the feedforward control value for controlling the fiber tape heating.

30. The system for controlling fiber tape heating of claim 29 wherein said memory device stores a feedforward data table of data points, each data point correlating a predefined velocity of the fiber tape, a predefined feedforward control value, and a predefined resulting temperature of the fiber tape.

31. The system for controlling fiber tape heating of claim 29 wherein the feedforward controller is further capable of providing the predefined control value as a heat control value, and the memory device is capable of storing the predefined velocity, the predefined feedforward control value, and the resulting temperature as a data point in the table of data points.

32. The system for controlling fiber tape heating of claim 29 wherein the feedforward controller is further capable of determining the feedforward control value by mathematically defining the feedforward control value according to a feedforward response surface and based upon the target temperature and the velocity of the fiber tape.

33. The system for controlling fiber tape heating of claim 29 wherein the feedforward controller is further capable of determining the feedforward control value by mathematically defining the feedforward control value as:
FCV(t)=B₀+B_{V}*V+B_{T}*T+B_{VT}*V*T+B_{TT}*T²
wherein FCV(t) is the feedforward control value as a function of time, T is the target temperature, V is the velocity of the fiber tape, and B₀, B_{V}, B_{T}, B_{VT}, and B_{TT} are predefined coefficients.

34. The system for controlling fiber tape heating of claim 29 wherein the heating device controller is further capable of determining the heat control value by summing the feedback control value and the feedforward control value.

35. The system for controlling fiber tape heating of claim 29 wherein the feedback controller determines the feedback control value utilizing proportional-integral-differential control.
